(19) United States
(12) Patent Application Publication
(10) Pub. No.: US 2008/0036686 A1
(43) Pub. Date: Feb. 14, 2008

(54) XYZ Isotropic Radiator Antenna

(76) Inventor: James Vincent Barone, Millersville, MD (US)

Correspondence Address: JAMES BARONE, 8329 WATERMILL DRIVE, MILLERSVILLE, MD, 21108, US

(21) Appl. No.: 11/480,737

(22) Filed: Aug. 9, 2006

(51) Int. Cl. H01Q 21/00

(52) U.S. Cl. 343/893; 343/901

(57) ABSTRACT

If God used a receiver his antenna would be an isotropic radiator. The sun is an isotropic radiator and the Point Source of our solar system. The sun's magnetic field and the gravitational field must also be an isotropic radiator. The XYZ Isotropic Radiator Antenna is a Point Source which exhibits the same magnitude or properties when measured in all directions. It has no preferred direction of radiation or plane polarization of radiation. It radiates uniformly in all directions over a heliocentric sphere centered on the source. It is a reference radiator with which other sources are compared. In antenna theory, the isotropic radiator is a perfect omni-directional antenna displaying isotropy. An isotropic radiator has a directivity of 1. Normally it is taken to emit a plane polarization such as horizontal or vertical polarization but now with this new hardware discovery we know the XYZ Isotropic Radiator Antenna uses a new XYZ Polarization Type radiation pattern. The XYZ Isotropic Radiator Antenna is shown in Photo 1 with the telescopic whips in there short 8 inch length (max length 40 inches).

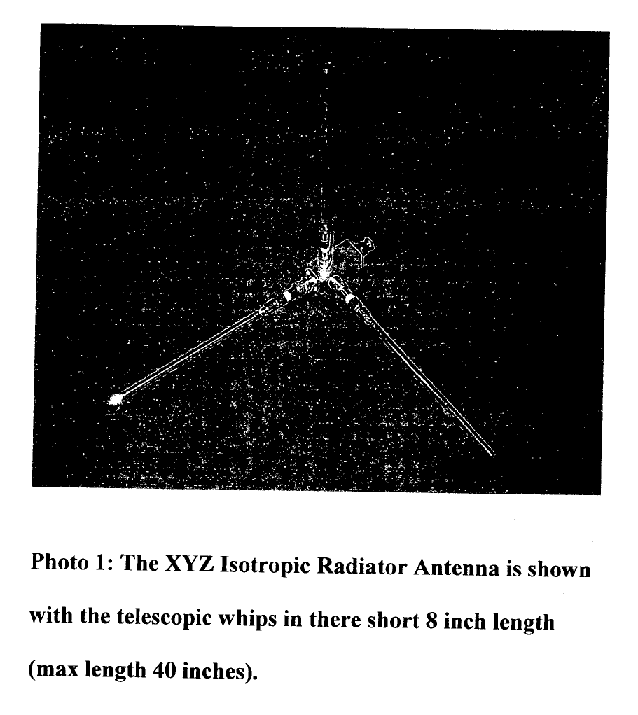

### BRIEF SUMMARY OF THE INVENTION

The XYZ Isotropic Radiator Antenna transmits and receives with a new XYZ Polarization Type.

### BRIEF DESCRIPTION OF THE DRAWING

Photo 1: The XYZ Isotropic Radiator Antenna is shown with the telescopic whips in there short 8 inch length (max length 40 inches).

### DETAILED DESCRIPTION OF THE INVENTION

The XYZ Isotropic Radiator Antenna is constructed with three identical metal elements (Russell Industries Strap-3 BNC 40 inch Telescopic Whips) positioned 90 degrees from each other and they are all connected electrically inside a shielded box at Point Source. The antenna elements receive Radio Frequency (RF) signals and conduct them into the shielded box. The shielded box (Pomona 2391 stock part box with BNC connectors on each end) with two additional BNC bulkhead receptacles (Amphenol part 31-221) installed near the stock shielded box BNC-Female bulkhead. The two additional and the stock BNC-Female bulkhead connectors are mounted on the box at 90 degree angles from each other. Inside the shielded box all three center pin ends of these connectors are located together and soldered together. Note, if center pin ends are too long just trim them off and solder all three together. Now wire with 20 gauge buss wire the three connectors to the BNC-Male bulkhead center pin on the other end of the shielded box. Close the box with the cover and screws. Connect the three 40 inch telescopic whips to the shielded box; they should all be perpendicular from the box and 90 degrees to each other. The XYZ Isotropic Radiator Antenna assembly is now complete.

The XYZ Isotropic Radiator Antenna combines three RF signals in the shielded box at Point Source; the Three Vector Addition and Subtraction provides one RF output signal Feed Source. Use 100% shielded coax cable from the Feed Source (shielded box BNC-Male output connector) to the receiver (not part of antenna). The Feed Source signal path must be protected from RF energy leakage into the receiver front end components. The double shielded coax cable, type RG223, can provide 80 dB of leakage protection.

The antenna resonance of the XYZ Isotropic Radiator Antenna is the RF in MHz where the antenna is in a state of electrical balance, and this determines the length of the X, Y and Z elements perpendicular to each other. The 40 inch XYZ Isotropic Radiator Antenna is 58 MHz at antenna resonance.

Velocity divided by F×12=wavelength×(XYZ factor)=XYZ (inches)

1000 divided by 58×12=206.896×0.19333=40 inches for X, Y and Z

The XYZ factor could be in the 5 to 20% range of antenna resonance wavelength and is dependent on the specific element hardware, length and size of Point Source and Feed Source connector hardware used in construction. Some alternate connectors like SMA, Type-N and elements made with solid and stranded wire and semi-rigid 141 cable could be used in construction of the XYZ Isotropic Radiator Antenna.

The XYZ Isotropic Radiator Antenna transmits and receives with a new XYZ Polarization Type. The three 90 degree phased RF fields form into one heliocentric sphere shaped radiation pattern with a directivity of one (1). Each whip provides a donut shape pattern and is ⅓ of an isotropic radiator. The three whips positioned 90 degrees perpendicular to each other will fill the pattern holes and provide for equal distance radius energy (field strengths) in all directions from the center of a radiating XYZ antenna. Note, near earth ground and the coax cable Feed Source to the antenna will cause some distortion of the pattern. Use the XYZ antenna with a short coax cable to the 50 ohm receiver, power meter/power sensor or spectrum analyzer. For long cable XYZ antenna operation use the XYZ Isotropic Radiator Antenna with a short coax cable to a RF preamplifier and long coax cable to the receiver. The XYZ antenna does not use balun transformers or matching circuit components; use a short Feed Source cable to the 50 ohm input devices such as preamps, power amplifiers and fixed power attenuators.

XYZ equal whip lengths RF tuning range 58-175 MHz (40-8 inches).

Antenna maximum RF input power 50 watts.

Three BNC-F and one BNC-M connectors mounted on 1 shielded box.

Three 40 inch Telescopic Whips are connected to three BNC-F.

The invention claimed is:

1. The XYZ Isotropic Radiator Antenna can transmit and receive Radio Frequency (RF) signals with a new XYZ Polarization Type that has a directivity of one (1).

2. The three whips positioned 90 degrees perpendicular to each other and connected together at Point Source will provide for equal distance radius energy (field strengths) in all directions from the center of the radiating XYZ Isotropic Radiator Antenna.

3. The three 90 degree phased RF fields form into one heliocentric sphere shaped radiation pattern with a directivity of one (1).

4. The XYZ Isotropic Radiator Antenna can receive energy from all other known polarizations types.

5. The XYZ Isotropic Radiator Antenna can only transmit a XYZ Polarization Type radiation pattern from a single Feed Source.

6. The XYZ Isotropic Radiator Antenna will provide a 7 to 8 dB gain over a plane polarized standard dipole or monopole antenna.

7. The XYZ Isotropic Radiator Antenna will provide an improved signal to noise ratio over the standard dipole or monopole antenna.
